(19) United States
(12) Patent Application Publication
(10) Pub. No.: US 2004/0236988 A1
(43) Pub. Date: Nov. 25, 2004

(54) Secure internal backup and archiving system

(76) Inventor: Frederic Sastrel, Chemin de Liecabre (FR)

Correspondence Address: James C. Lydon, Suite 100, 100 Daingerfield Road, Alexandria, VA, 22314, US

(21) Appl. No.: 10/457,541

(22) Filed: Jun. 10, 2003

(30) Foreign Application Priority Data
May 7, 2003 (FR) 03/05581

(51) Int. Cl. H02H 3/05

(52) U.S. Cl. 714/13

(57) ABSTRACT

A backup system (1) for computer data stored in the memory of a computer, a server or similar device (2) controlled by a backup software installed on the computer, consisting of a cabinet (15) in which a backup hard disk (10) linked to the computer, server or similar device is installed and designed to backup computer data controlled by the backup software and a thermal dissipation heat sink (14) in contact with the hard disk, the cabinet being placed in a fire-resistant enclosure (20).

This invention concerns a backup system for computer data and, in particular, a secure internal data backup and archiving system.

Information technology has made data backup and archiving systems essential for all companies. In fact, loss of computer data can have serious consequences, especially for SMEs. Nevertheless, there may be several causes for loss of data. This may include, among others, a user error, hardware failure, theft of hardware, virus or natural hazards such as flooding, fire or explosion. Several backup solutions are offered to companies for dealing with such contingencies.

One possible solution is to have two hard disks, one of which is dedicated to backup and archiving. This type of backup has the advantage of being totally automatic and requires no manual handling of the media such as a tape. Nevertheless, it has the disadvantage of being exposed to hardware theft or natural risk.

Another solution consists in performing backups on a storage media. This media can be a DAT tape, a ZIP disk or a CD. Thus, a backup copy may be stored at a location that is different from where the original information is stored. The major disadvantage of this kind of backup lies in the need for human intervention to regularly replace the media and the related risks of forgetting such tasks. Furthermore, DAT tapes don't always accept all types of data and ZIP disks and CDs have a small storage capacity.

A third solution consists in outsourcing the backup. In this way, the user does not handle the backup himself/herself, and the data medium is not exposed to handling errors or theft. This mode of backing up gets round data loss caused by natural hazards. It also has the advantage of providing the user with some comfort since he/she can regularly be kept informed about the status of the backups. The disadvantages of this type of solution lie in the fact that data has to go out of the company and the high cost of the operation due to the intervention of a subcontracting company.

That's why, the purpose of the invention is to provide an efficient and secure system for automatic backup of computer data, within the company, requiring minimum manual intervention and enabling the user to automatically keep himself/herself informed about the status of the backup.

Another purpose of the invention is to provide a backup system that is protected against water and fire and capable of regulating the internal temperature in order to ensure that the temperature of the hard disk does not reach the maximum permissible temperature.

The object of the invention is therefore a backup system for computer data stored in the memory of a computer, server or similar device controlled by backup software installed on the computer. This system includes a cabinet in which there is a backup hard disk connected to the computer or server or similar device, designed to backup computer data controlled by the backup software and a heat dissipation sink in contact with the hard disk, the cabinet being placed within a fire-resistant enclosure.

The purposes, objects and characteristics of the invention will become more apparent from the following description when taken in conjunction with the accompanying drawings in which:

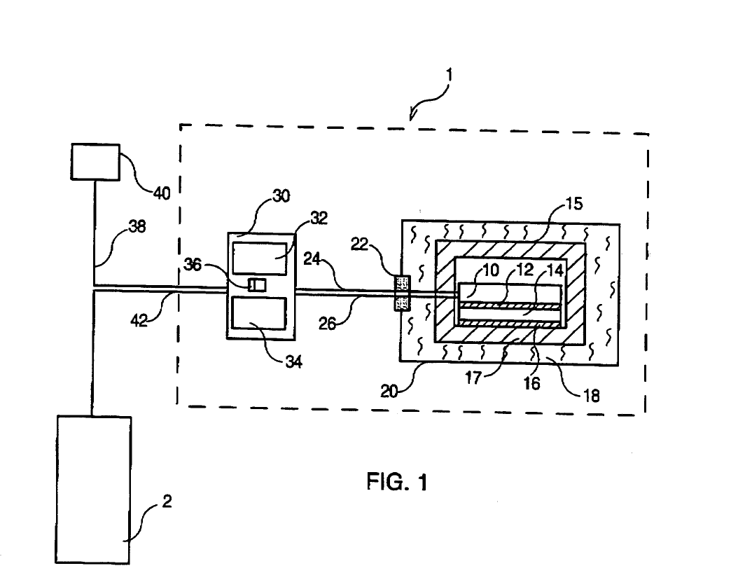

FIG. 1 represents in detail the backup system and its resources for securement according to the invention,

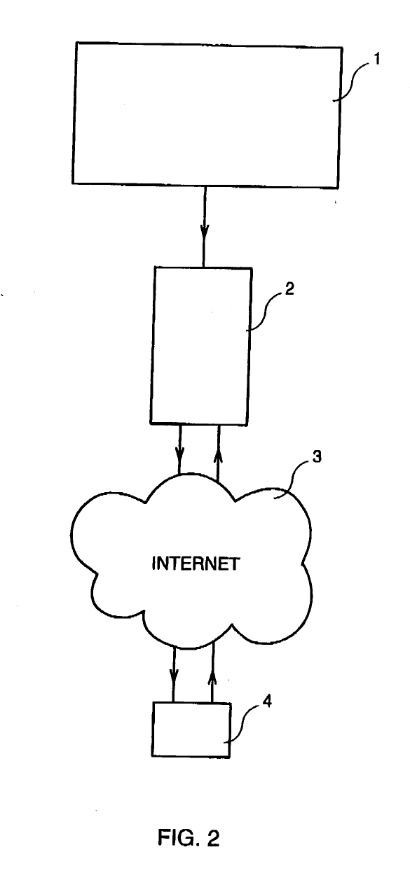

FIG. 2 represents the backup system as a whole according to the invention.

According to FIG. 1, the system according to the invention includes an IDE hard disk 10 with a capacity of 40, 80 or 120 Gigabytes. The hard disk is, preferably, a 7200-rpm disk. A standard heat dissipation sink 14 is screwed on to the hard disk, with dimensions of 150 mm×108 mm×14 mm (L×b×h) and a thermal resistance of 2.35° C./W, for example. In order to increase the contact area between the hard disk and the heat sink and thus improve the transfer of heat from the hard disk to the heat sink, a layer of thermal grease 12, about 1 mm thick, with a strong thermal conductivity (in the order of 8 W/m. ° K) is inserted between the hard disk and the heat sink. The hard disk and the heat sink are placed in an aluminum cabinet 15 measuring 188 mm×120 mm×82 mm (L×b×h) and having a thickness of 1 mm. The heat sink is fixed in the cabinet using screws. In order to improve the transfer of heat from the heat sink to the cabinet, a second layer of thermal grease 16, about 1 mm thick, may also be added between the heat sink and the cabinet. The assembly consisting of the cabinet 15, the heat sink and at least one layer of thermal grease 12 and/or 16 is sized in such a way that heat may be dissipated from the hard disk during operation so that the internal temperature of the cabinet remains around 47° C. and never exceeds 52° C.

It should be noted that it is preferable to place a pouch with humidity absorbent material inside the cabinet 15, to protect the hard disk in case of excessive relative humidity.

The hard disk 10, in its cabinet 15 is placed in a fire-resistant and watertight enclosure 20 provided with an opening. The external dimensions of the enclosure are in the order of 360 mm×280 mm×21 mm (L×b×h), for example. The fire-resistant enclosure 20 is made of a thin layer of hard and shock-resistant material, such as high-density polyethylene and lined on the inside with a fire-resistant material preferably in two layers. The inner layer 17 is made of a 4 cm thick fire-resistant material and the outer layer 18 is made of a 3 cm thick fire-resistant material. The fire-resistant material comprising the layers 17 and 18 is preferably made of Portland cement and is capable of resisting fire. The water-tightness of the enclosure 20 against splashes of water becomes operational the moment the enclosure is closed. The hard disk is linked to an external interface 30 through two cables. The first is a supply cable 24 that carries a voltage of 5V and the second is an IDE ribbon cable 26. The passage of the two cables 24 and 26 from the cabinet 15 to outside the enclosure 20 acts as a thermal bridge between the cabinet and its surroundings.

The external interface 30 includes a power supply board 32, a USB card 34 and a switch 36. It is attached to one of the walls of the enclosure, preferably on the outside. In order to break this bridge and complete the thermal insulation of the assembly, a layer of refractory mastic 22 is injected into the recess of the enclosure 20 from where the cables 24 and 26 come out.

The external interface 30 enables the connection of a supply cable 38 to a 12V DC supply 40 and a USB cable 42 to a computer 2.

Once the cabinet and its contents as described above are placed in the closed enclosure 20, the entire assembly is thermally insulated from the surroundings in such a way that, placed in extreme conditions such as a fire, the temperature inside the cabinet 15 is maintained at less than 52° C. in normal external ambient temperature conditions. Tests carried out over a period of 17 days, during which the hard disk was accessed 24 h×24, have shown that the temperature does not exceed 43° C. A hard disk that operates normally dissipates maximum heat when it is functioning, that is to say when data is being stored or accessed.

Similarly, when the fire-resistant enclosure 20 is exposed to a fire at 850° C. for half an hour, the temperature inside the cabinet (15) does not exceed 52° C.

The user thus backs up data from his/her computer or his/her server 2 on the hard disk 10 regularly, preferably every day, thanks to a backup software installed and set up beforehand on the hard disk 10. A monitoring and alert software is also installed on the computer 2. This software monitors whether the backup has been successfully completed. With reference to FIG. 2, this software also keeps at least one user informed by sending an electronic message through an Internet connection 3 to the computer 2, via an appropriate server 4, of details relating to the backup such as the date and time, the number of files backed up, the compression ratio and the remaining hard disk space. No information concerning the contents of the backup is available. The user can himself/herself choose the list of persons who need to be informed about the backup through a website and the server 4. If the user(s) does not (do not) receive any message within the backup period, 24 hours here, a warning message is automatically sent to the user by the server 4.

This monitoring software has the advantage of remotely informing the users about the status of the backups performed, without the latter having access to the contents of the backup at any time.

The backup system according to the invention also has means to protect itself from data theft. Actually, when information is backed up, an encryption software encrypts the backed up data thus making it unreadable. Thus, even if an ill-intentioned person gets hold of the backup system 1, he/she cannot use the information from the disk. Moreover, the backup, monitoring and alert software packages are proprietary software with a login. Therefore, only the user who owns the computer 2 is authorized to decrypt information from the disk and read it. It is also possible to fit the backup system 1 with an anti-theft device so that the enclosure 20 remains locked. According to an additional anti-theft mode, the enclosure 20 fixed securely to the ground.

In one preferred embodiment of the invention, the enclosure 20 has the shape of a suitcase. Thus, the backup system according to the invention has the advantage of being easily transportable, particularly as its total weight is less than 20 kg. In another embodiment of the invention, the fire-resistant enclosure 20 is a safe from the SENTRY FIRE-SAFE no. 1710 range of products approved by UL (Underwriters Laboratories).

In order to double the backup capacity, it is also possible to install two IDE-type hard disks of 40, 80 or 120 Gigabytes capacity, preferably with a speed of 7200 rpm, in a fire-resistant enclosure of larger dimensions. In this case, each disk, fixed to a heat sink, is placed in an aluminum cabinet in the same way as described previously for a single hard disk. Both cabinets are then placed side by side in a fire-resistant enclosure lined with at least two layers of fire-resistant material. Just as for the backup system with a single hard disk, both disks are connected to an external interface through a supply cable and IDE ribbon cable. The external interface, attached to one of the walls of the enclosure is provided with a network card and a power supply board, and is connected to a computer, a server or similar device containing the data to be backed up. The external dimensions of the enclosure are in the order of 390 mm×310 mm×35 mm (L×w×h).

1-11. (Cancelled)

12. A backup system for computer data stored in the memory of a computer, server or similar device controlled by a backup software installed on said computer, comprising
a cabinet in which there is a backup hard disk connected to said computer or server or similar device and designed to backup said computer data controlled by said backup software and a heat dissipation sink in contact with said hard disk, said cabinet being placed within a fire-resistant enclosure.

13. The backup system of claim 12, wherein said cabinet is made of aluminum and is placed within a fire-resistant and water-tight chamber in said enclosure, and said hard disk is connected to an external interface through connecting cables including a supply cable and an IDE ribbon cable, said external interface being fixed to one of the walls of said enclosure.

14. The backup system of claim 12, further comprising a monitoring and alert software installed on the computer, server or similar device, said software enabling, through the Internet and a server, the sending of electronic messages to at least one user for automatically informing him/her on the status of the backup, on the one hand, and to automatically warn him/her in case the backup fails on the other hand, without the contents of the backup being accessible.

15. The system of claim 12, wherein said heat dissipation sink is adapted to diffuse heat produced by the hard disk towards said cabinet with the help of at least one layer of grease having a thermal conductivity of 8 W/m. K.

16. The backup system of claim 12, wherein said enclosure is a suitcase.

17. The backup system of claim 13, wherein said fire-resistant and water-tight chamber is made of at least two separate layers of fire-resistant material.

18. The backup system of claim 13, wherein said external interface comprises a USB card and a power supply board.

19. The backup system of claim 13, further comprising a refractory mastic adapted to thermally insulate said connecting cables from the surroundings of said cabinet.

20. The backup system of claim 12, wherein the data backed up on the hard disk is encrypted by means of an encryption software installed on the computer.

21. The backup system of claim 12, wherein two hard disks, each fixed to a heat dissipation sink, are each placed inside an aluminum cabinet, said cabinet being placed inside a fire-resistant and water-tight chamber in an enclosure and said hard disks are connected to an external interface through a supply cable and an IDE ribbon cable, said external interface being attached to one of the walls of said enclosure.

22. The backup system of claim 12, further comprising an anti-theft device adapted to lock said enclosure containing at least one hard disk.
